(19) United States
(12) Patent Application Publication
(10) Pub. No.: US 2011/0218953 A1
(43) Pub. Date: Sep. 8, 2011

(54) DESIGN OF SYSTEMS FOR IMPROVED HUMAN INTERACTION

(76) Inventors: Kelly S. Hale, Orlando, FL (US); Leaha M. Reeves, Alexandria, VA (US); Kay M. Stanney, Oviedo, FL (US)

(21) Appl. No.: 13/111,138

(22) Filed: May 19, 2011

Related U.S. Application Data
(62) Division of application No. 11/457,061, filed on Jul. 12, 2006.
(60) Provisional application No. 60/698,531, filed on Jul. 12, 2005.

(51) Int. Cl. G06F 17/50; G06N 5/02

(52) U.S. Cl. 706/46

(57) ABSTRACT

A method for evaluating a human interface of a system for appropriate allocation of design guidance including establishing guidelines for avoiding sensory overload conditions of a human interacting with a system, identifying an event associated with the system producing a potential sensory overload condition, and generating a human interface design recommendation based on the guidelines for modifying an operation of the system to help alleviate the potential sensory overload condition associated with the event.

### CROSS-REFERENCE TO RELATED APPLICATIONS

This application claims priority to and is a Divisional of U.S. application Ser. No. 11/457,061 filed Jul. 12, 2006, which claims the benefit of U.S. Provisional Application No. 60/698,531 filed Jul. 12, 2005, and incorporated herein by reference in its entirety.

### STATEMENT REGARDING FEDERALLY SPONSORED RESEARCH OR DEVELOPMENT

The U.S. Government has certain rights in this invention under contract number N61339-04-C-0037 awarded by NAVAIR.

### BACKGROUND OF THE INVENTION

The present invention relates to human interface design and, in particular, to optimizing a human interface of a system to improve a system operator's ability to process information provided via the system.

Today's military relies heavily on complex information systems, such as Command, Control, Communications, Computers, Intelligence, Surveillance, and Reconnaissance (C4ISR) systems, to gather information, monitor ongoing operations, and plan missions. In recent years, the amount of information an operator of such an information system must process and react to has risen dramatically. Consequently, the challenge of how to organize and present the vast amount of available data to operators so they can effectively and efficiently complete their missions is becoming increasingly more difficult. Traditionally, improving information processing capability to limit sensory and work overloads has focused on a layout of controls and information displays of the system and/or adding more operators to control and monitor the systems. However, sensory and work overload conditions are still encountered by operators of these systems.

### BRIEF DESCRIPTION OF THE INVENTION

A method for evaluating a human interface of a system for appropriate allocation of design guidance is disclosed. The method comprises establishing guidelines for avoiding sensory overload conditions of a human interacting with a system, identifying an event associated with the system producing a potential sensory overload condition, and generating a human interface design recommendation based on the guidelines for modifying an operation of the system to help alleviate the potential sensory overload condition associated with the event. In an exemplary embodiment, the method is performed with at least one processor.

### BRIEF DESCRIPTION OF THE DRAWINGS

FIG. 1 shows a flow chart for an example method for designing a human interface of an information system.

FIG. 2 shows a flow chart for an example method for predicting a performance capability of a human subject interacting with an information system.

### DETAILED DESCRIPTION OF THE INVENTION

The present invention is directed to design of systems for improved human interaction, for example, by ensuring that such systems present information in ways that reduce sensory and/or work overload conditions experienced by operators of the system. The inventors have realized that by providing systematic human interface design solutions for modifying information presentation of a system to better match demands with human perceptual and cognitive abilities, improved situational awareness and reduced sensory and work overload conditions of operators using such systems may be achieved.

In an embodiment, the invention automatically identifies, based on the events generated by a system, how to present information to an operator via different sensory channels, or multi-modally, to ensure critical tasks are perceived and comprehended accurately and acted upon in a timely fashion. For example, while using a visual light, i.e., a visual sensory channel, to indicate an imminent problem may be effective in a single display system, this type of presentation may not be effective when an operator is monitoring two or more visual displays at a time. Instead, an appropriate auditory and/or haptic alarm generated by the system may be implemented to ensure operators acknowledge and react to critical issues immediately and prevent further complications. Accordingly, when such a sensory overload situation is identified, one or more design solutions, such as a suggestion to provide an auditory or haptic alarm, may be automatically generated for alleviating the situation. By automatically providing human interface design solutions for presenting information more effectively, information display design may be simplified and design times may be decreased compared to conventional design techniques.

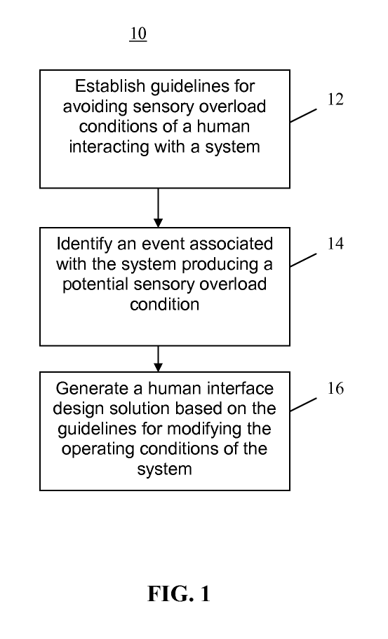

FIG. 1 shows a flow chart 10 of an example method for designing a human interface of a system. The method includes establishing guidelines for avoiding a sensory overload condition of a human interacting with an information system 12. Such guidelines may be derived from known guidelines for alleviating potential sensory overload conditions of a human interacting with an information systems via visual, auditory, haptic, and multi-modal sensory channels. A list of example guidelines for alleviating sensory overload conditions and associated rationale behind the guidelines is shown in Table 2:

TABLE 2
Example Guidelines for Remedying a Sensory Overload Condition
of a Human Interacting with an Information System

| | Sensory | | |
|---|---|---|---|
| | Channel | Guideline | Rationale |
| 1 | Visual | Avoid absolute | Individuals are much better at |
| | | judgment | distinguishing among different colors |
| | | (recognition tasks) | than at recognizing a particular color. |
| | | via color. | Therefore, avoid absolute judgment |
| | | | (“recognize”) tasks; design displays so |
| | | | that they require relative judgment |
| | | | (“distinguish”) tasks. |
| 2 | Visual | Design displays | Individuals are much better at |
| | | such that they | distinguishing among different colors |
| | | require relative | than at recognizing a particular color. |
| | | judgment via color | Therefore, avoid absolute judgment |
| | | (differentiation | (“recognize”) tasks; design displays so |
| | | tasks) | that they require relative judgment |
| | | | (“distinguish”) tasks. |
| 3 | Visual | Distribute attention | Visual information processing for |
| | | amongst a range of | color, shape, and motion are |
| | | visual | distributed across distinct brain |
| | | characteristics of | regions. Leveraging these areas may |
| | | objects (i.e., shape, | reduce visual cognitive overload |
| | | color, speed) to | |
| | | minimize cognitive | |
| | | workload | |
| 4 | Visual | Graphics are better | Visual graphs are better when they use |
| | | than text or | spatial relations in ways that help a |
| | | auditory | person ‘see’ relationships in the |
| | | instructions for | graphics. |
| | | communicating | |
| | | spatial information | |
| 5 | Visual | Make sure that the | Studies have suggested that |
| | | display can be | approximately 8% of males and less |
| | | used without color | than 0.5% females have color |
| | | (e.g., for color- | deficiencies. Therefore, when |
| | | blind individuals) | designing color displays, create |
| | | | elements that can be displayed without |
| | | | color. |
| 6 | Visual | Objects should be | Visual processing are restricted to |
| | | restricted to a field | limited field of view of 180 degrees |
| | | of 180° | horizontally and 130 degrees |
| | | horizontally and | vertically. |
| | | 130° vertically | |
| 7 | Visual | Present highest | Spatial tasks are best processed via |
| | | priority spatial task | visual channels. Vision dominates |
| | | using visual | spatial acuity since its acuity is about 1 |
| | | channel instead of | min of arc as opposed to 1 deg for |
| | | auditory channel. | hearing. |
| 8 | Visual | Present one task at | To reduce visual overload and |
| | | a time: Hold | optimize visual processing, present |
| | | lowest priority task | highest priority visually. |
| | | in cue until highest | |
| | | priority task is | |
| | | complete. | |
| 9 | Visual | Reaction time to | Visual cues require additional |
| | | visual stimuli | processing due to the complication of |
| | | (180-200 msec) is | visual messages (i.e., shape, color, |
| | | slower than | motion). |
| | | auditory (140-160 | |
| | | msec) and haptic | |
| | | (155 msec), thus it | |
| | | is best to use | |
| | | visual alerts and | |
| | | warnings only | |
| | | when these other | |
| | | modalities are | |
| | | loaded | |
| 10 | Visual | Text is better than | For optimal processing, when |
| | | speech for | conveying detailed and long |
| | | conveying | information visual text is better than |
| | | detailed, long | auditory speech since audition tends to |
| | | information | be transient. Due to its fleeting nature, |
| | | | speech will not be available for later |
| | | | review. |
| 11 | Visual | To examine object | Visual acuity is optimal in the center |
| | | details, place | of the fovea, approximately two |
| | | object within | degrees of retina. Visual acuity is |
| | | foveal vision | about 1 min of arc. |
| | | (central 2° of | |
| | | retina) | |
| 12 | Visual | Use animation to | Visual animation is critical to |
| | | demonstrate | understand a task. Animation is best |
| | | sequential actions | used as an interactive technique for |
| | | in procedural | accuracy of decision making tasks and |
| | | tasks, simulate | should be used when related to |
| | | causal models of | instructional objectives |
| | | complex system | |
| | | behavior, and | |
| | | explicitly represent | |
| | | invisible system | |
| | | functions and | |
| | | behaviors | |
| 13 | Visual | Use color to aid | Color coding is effective for visual |
| | | visual search by | search. The advantage of color is that |
| | | making images | it “catches the eye” more than other |
| | | discriminable from | visual codes. |
| | | one another | |
| 14 | Visual | Use congruent | The congruency effectiveness rule |
| | | pairings of color | suggests that certain congruent |
| | | and position to | combinations of cross-modal percepts |
| | | reduce reaction | will yield significantly faster RT than |
| | | time | incongruent combinations |
| 15 | Visual | Use congruent | The congruency effectiveness rule |
| | | pairings of pitch | suggests that certain congruent |
| | | and position to | combinations of cross-modal percepts |
| | | reduce reaction | will yield significantly faster RT than |
| | | time | incongruent combinations. RTs may |
| | | | be significantly shorter for congruent |
| | | | pairings of high pitch-high position |
| | | | (object placed above fixation on visual |
| | | | display) and low pitch-low position |
| | | | (object placed below fixation on visual |
| | | | display) pairings relative to RTs of |
| | | | incongruent pairings. A combination |
| | | | of pitch and color has been used to |
| | | | generate shorter RTs for congruent |
| | | | stimuli of white color-high pitch or |
| | | | black color-low pitch, as opposed to |
| | | | incongruent pairings (e.g., black color- |
| | | | high pitch). |
| 16 | Visual | Use flow charts to | Visual graphs are better when they use |
| | | show relationships | spatial relations in ways that help a |
| | | or steps involved | person ‘see’ relationships in the |
| | | in a process | graphics. |
| 17 | Visual | Use Gestalt Rules | To increase visual information |
| | | to increase users' | processing, enhance perceptual coding |
| | | understanding of | via Gestalt principles of proximity, |
| | | relationships | similarity, and closure. These |
| | | between elements | principles include placing related |
| | | | objects close together, enclosing |
| | | | related objects by lines or boxes, |
| | | | moving or changing related objects |
| | | | together, and ensuring related objects |
| | | | look alike (e.g., shape, color, size, |
| | | | topography). |
| 18 | Visual | Use motion to | To aid in visual direction, animate |
| | | enhance detection | visual images when object are not in |
| | | of objects in the | central foveal view or when display |
| | | periphery or | contains low illumination |
| | | overcome poor | |
| | | illumination | |
| 19 | Visual | Use numbered lists | Depict visual items with numbers to |
| | | to show groups of | display order and relationships |
| | | related items with | amongst objects. |
| | | a specific order | |
| 20 | Visual | Use tables, | Visual graphs are better when they use |
| | | matrices, bar | spatial relations in ways that help a |
| | | charts, pie charts | person ‘see’ relationships in the |
| | | to help a person | graphics. |
| | | ‘see’ relationships | |
| | | in the graphics. | |
| 21 | Visual | Use visual | Visual graphs are better when they use |
| | | graphics for | spatial relations in ways that help a |
| | | communicating | person ‘see’ relationships in the |
| | | spatial information | graphics. |
| 22 | Visual | Use visual text for | For optimal processing, when |
| | | conveying | conveying detailed and long |
| | | detailed, long | information visual text is best since it |
| | | information. | is permanent for operators to refer |
| | | | back to the message. |
| 23 | Auditory | A warning sound | |
| | | must be 15 dB | |
| | | above the | |
| | | threshold imposed | |
| | | by background | |
| | | noise to be heard | |
| | | clearly. | |
| 24 | Auditory | Add spatialized | |
| | | audio to aid | |
| | | identification of | |
| | | auditory verbal | |
| | | messages in noisy | |
| | | environments. | |
| 25 | Auditory | Auditory cues can | |
| | | be spatialized to | |
| | | indicate direction, | |
| | | location, and | |
| | | movement | |
| 26 | Auditory | Auditory icons are | Auditory icons are vocal sounds that |
| | | useful when visual | semantically relate |
| | | channel | environmental sounds to a given |
| | | overloaded | object (e.g., use the sound of a door |
| | | | opening to open a file). A listener's |
| | | | interpretation of the physical sound is |
| | | | considered a “sound symbol.” |
| | | | Auditory icons are useful in complex |
| | | | environments where users are visually |
| | | | overloaded; they are generally easy to |
| | | | learn and thus should be used for |
| | | | systems that require minimal training. |
| 27 | Auditory | If combining | |
| | | intensity | |
| | | differences with | |
| | | other auditory | |
| | | cues, use a | |
| | | minimum intensity | |
| | | of 10 dB above | |
| | | threshold and | |
| | | maximum intensity | |
| | | of 20 dB above | |
| | | threshold | |
| 28 | Auditory | If duration <500 | |
| | | ms, increase | |
| | | intensity to | |
| | | compensate for | |
| | | audibility (Sanders | |
| | | & McCormick, | |
| | | 1993) as sounds | |
| | | shorter than 500 | |
| | | ms may not be | |
| | | perceived. | |
| 29 | Auditory | Intensity should | |
| | | not be used alone | |
| | | for differentiating | |
| | | earcons | |
| 30 | Auditory | If pitch, register or | |
| | | rhythm are used | |
| | | alone to make | |
| | | absolute sound | |
| | | judgments, use a | |
| | | large difference | |
| | | between earcons | |
| | | (pitch: 125 Hz-5 | |
| | | kHz; register: 3 or | |
| | | more octaves; | |
| | | rhythm: different | |
| | | number of notes in | |
| | | each) | |
| 31 | Auditory | Keep auditory | Due to its transient nature, auditory |
| | | warning messages | information needs to be dealt with |
| | | simple and short | immediately. Only messages that will |
| | | | not be referred to at a later time should |
| | | | be conveyed via auditory displays. |
| | | | Auditory displays are thus preferred |
| | | | when information is simple and short. |
| | | | Limit recall of auditory items to about |
| | | | 3 or 4 elements. |
| 32 | Auditory | Keep auditory | |
| | | warning messages | |
| | | simple and short | |
| 33 | Auditory | Present one | |
| | | auditory task at a | |
| | | time: Hold lowest | |
| | | priority verbal task | |
| | | in cue until highest | |
| | | priority task is | |
| | | complete. | |
| 34 | Auditory | Present highest | Current understanding of Wickens' |
| | | priority verbal task | Stimulus-Central Processing-Response |
| | | using audio instead | compatibility (S-C-R) schemes is that |
| | | of visual input. | tasks demanding “verbal” WM, such |
| | | | as interpretation of system status, are |
| | | | thought to be best presented via |
| | | | audition (i.e., speech). |
| 35 | Auditory | Present low | |
| | | complexity, high | |
| | | priority | |
| | | information | |
| | | through the | |
| | | auditory channel. | |
| 36 | Auditory | Present lowest | To reduce visual overload and |
| | | priority spatial task | optimize visual processing, present |
| | | using spatialized | highest priority visually. Spatialized |
| | | audio cues instead | audio cues can be used to present a |
| | | of visual input | lower priority task. |
| 37 | Auditory | Present short lists | |
| | | using auditory | |
| | | channel instead of | |
| | | visual text. | |
| 38 | Auditory | Provide auditory | Providing auditory instructions will |
| | | rather than textual | minimize interference in the visual |
| | | instructions when | channel. |
| | | a listener is | |
| | | performing a | |
| | | visual task | |
| 39 | Auditory | Simulate human | |
| | | voices as much as | |
| | | possible when | |
| | | using speech | |
| 40 | Auditory | Speech is most | |
| | | effective for rapid, | |
| | | complex | |
| | | information | |
| 41 | Auditory | Use auditory icons | Auditory icons are vocal sounds that |
| | | (with real world | semantically relate |
| | | sounds) to enhance | environmental sounds to a given |
| | | their recognizability | object (e.g., use the sound of a door |
| | | | opening to open a file). A listener's |
| | | | interpretation of the physical sound is |
| | | | considered a “sound symbol.” |
| | | | Auditory icons are useful in complex |
| | | | environments where users are visually |
| | | | overloaded; they are generally easy to |
| | | | learn and thus should be used for |
| | | | systems that require minimal training. |
| 42 | Auditory | Use auditory | Due to its transient nature, auditory |
| | | messages if | information needs to be dealt with |
| | | dealing with time | immediately. Only messages that will |
| | | relevant events, | not be referred to at a later time should |
| | | continuously | be conveyed via auditory displays. |
| | | changing | Auditory displays are thus preferred |
| | | information, or | when information is simple and short. |
| | | when requiring | Auditory warning cues are superior to |
| | | immediate action | visual warnings and are better used |
| | | | when fast reaction time is essential (30 |
| | | | to 40 ms faster than vision). |
| 43 | Auditory | Use complex | Multiple encoding mechanisms for |
| | | sounds for alarms | sound, such as frequency, amplitude, |
| | | | and duration, can be used to aid in |
| | | | distinguishing among auditory |
| | | | signals). Auditory warning alerts are |
| | | | designed to use redundant dimensions |
| | | | such as pitch, timbre, and interruption |
| | | | rates. Auditory warning cues are |
| | | | superior to visual warnings and are |
| | | | better used when fast reaction time is |
| | | | essential (30 to 40 ms faster than |
| | | | vision). |
| 44 | Auditory | Use different | |
| | | voices for different | |
| | | interface elements | |
| 45 | Auditory | Use speech as a | |
| | | response method if | |
| | | user's hands are | |
| | | busy. | |
| 46 | Auditory | Use timbres with | Earcons use abstract, synthetic sounds |
| | | multiple harmonics | in structured combinations to represent |
| | | to aid perception | objects, interactions, or operations. For |
| | | of critical items | example, the size and type of a file |
| | | while avoiding | may be conveyed aurally (e.g., |
| | | masking | increase pitch to indicate a large file). |
| | | | Tones are good for communicating |
| | | | limited information sources (e.g., start |
| | | | or stop times) and may be used as |
| | | | complex sounds (i.e., using timbre as a |
| | | | grouping cue). Music may be used to |
| | | | combine sounds from various rhythms |
| | | | to provide an inherent structure that |
| | | | one can map to the structure of a |
| | | | dataset. Additionally, harmonic |
| | | | structures may be used to convey |
| | | | semantic). |
| 47 | Auditory | When playing | |
| | | sequential earcons, | |
| | | use a 0.1 s delay | |
| | | between them so | |
| | | listeners can tell | |
| | | when one finishes | |
| | | and the next | |
| | | commences | |
| 48 | Haptic | Gestures can be | Gestures should be intuitive and |
| | | used to | simple; avoid increasing user's |
| | | communicate | cognitive load with too numerous |
| | | meaningful | and/or complex. |
| | | information in | Avoid frequent, awkward or precise |
| | | isolation or in | gestures. |
| | | combination with | |
| | | speech and/or | |
| | | visual information | |
| 49 | Haptic | Tactile cues can be | |
| | | augmented by or | |
| | | substituted for | |
| | | visual tasks to aid | |
| | | localization | |
| 50 | Haptic | Vibratory cues can | Reaction time to haptic stimuli is |
| | | replace auditory | 40 ms shorter than reaction time to |
| | | cues for | visual (similar RT to auditory); thus |
| | | alerts/warnings | the haptic sense may serve as an |
| | | | effective warning signal. |
| 51 | Haptic | Add tactile cues to | Tactile cues are effective at grabbing |
| | | spatial tasks to aid | attention. Adding spatial tactile cues to |
| | | localization. | a visual scene may increase |
| | | | performance on spatial orientation |
| | | | tasks by grabbing attention towards |
| | | | visual display of interest. Tactile cues |
| | | | should not be used alone as they may |
| | | | not be ideal for quickly and precisely |
| | | | directing attention (although are |
| | | | effective at grabbing attention). |
| 52 | Haptic | Avoid | The motor system brain areas include |
| | | unpredictable | the brain stem, primary motor cortex, |
| | | tactile stimuli, as | associational cortex, basal ganglia, |
| | | they tend to | cerebellum, and the premotor cortex |
| | | increase cortical | and supplemental motor area (SMA) |
| | | activation | in the frontal lobe. Increased cortical |
| | | | activation across these areas has been |
| | | | documented when the stimulus to |
| | | | which one must respond is |
| | | | unpredictable. |
| 53 | Haptic | Present lowest | To reduce visual overload and |
| | | priority spatial task | optimize visual processing, present |
| | | using spatialized | highest priority visually. Spatialized |
| | | tactile cues instead | tactile cues can be used to present a |
| | | of visual input | lower priority task. |
| 54 | Haptic | Stimuli must be | |
| | | separated by at | |
| | | least 5.5 ms to be | |
| | | perceived as | |
| | | individual signals | |
| 55 | Haptic | Tactile cues can be | Although visuo-spatial information is |
| | | augmented by or | thought to be best presented via visual |
| | | substituted for | imagery, it could alternatively be |
| | | visual tasks to aid | conveyed via vibratory cues. For |
| | | localization | example, it has been demonstrated that |
| | | | the ability to substitute spatial |
| | | | information presented visually via |
| | | | tactile ‘vision.’ It has been |
| | | | demonstrated that tactile sensors can |
| | | | be effectively used to provide cues to |
| | | | resolve spatial disorientation in |
| | | | aviation environments. A Haptic |
| | | | driving navigation guidance system |
| | | | has been proposed that leverages a |
| | | | spatiotemporal illusion of movement |
| | | | across the back known as “sensory |
| | | | saltation,” which places three to six |
| | | | mechanical sensors that emit vibratory |
| | | | pulses with an interstimulus duration |
| | | | of 50 ms no greater than 10 cm apart |
| | | | along the back. |
| 56 | Haptic | Use force <4.7N | |
| | | if sustained | |
| | | fingertip press | |
| | | required | |
| 57 | Haptic | Users should be | |
| | | able to actively | |
| | | search and survey | |
| | | the environment | |
| | | via touch and | |
| | | easily identify | |
| | | objects through | |
| | | physical | |
| | | interaction | |
| 58 | Multimodal | Add a tactile cue | Results show that reaction times are |
| | | to direct | faster when visual stimuli is presented |
| | | multimodal | following a tactile cue directing |
| | | interaction. | attention to the cued side. Multimodal |
| | | | cueing is thought to be based on |
| | | | external locations in space (posture- |
| | | | independent), not on a hemispheric |
| | | | (anatomical) model. |
| 59 | Multimodal | Add spatialized | It is known that the use of spatialized |
| | | audio to visual | audio in visual target detection and |
| | | target detection | presentation of 3D audio cues, |
| | | tasks to decrease | emanating from the same spatial |
| | | search times | location as a visual target, decreases |
| | | | search times. Auditory cues may be |
| | | | useful in visual target detection |
| | | | especially when a shift in gaze was |
| | | | required. |
| | | | A ‘frontal speech advantage’ has been |
| | | | demonstrated, where participants' |
| | | | driving performance increased when |
| | | | the focus of visual and auditory |
| | | | attention were from the same source |
| | | | (straight ahead) rather than when |
| | | | attention was divided between front |
| | | | (visual) and side (auditory) (e.g., as |
| | | | with a cellular phone ear piece). Thus, |
| | | | locate acoustic and visual stimuli |
| | | | within 160 of one another to produce |
| | | | greatest benefits. |
| 60 | Multimodal | Auditory cues | Audition aids in re-direction of gaze |
| | | added to a visual | by focusing a user's attention on |
| | | target detection | events in an environment. |
| | | task are beneficial, | |
| | | especially when a | |
| | | shift in gaze is | |
| | | required (e.g., in | |
| | | the periphery) | |
| 61 | Multimodal | Auditory signals | |
| | | can be coupled to | |
| | | haptic signals to | |
| | | increase reaction | |
| | | time | |
| 62 | Multimodal | Combine tactile | Tactile cues are effective at grabbing |
| | | cues with the | attention. Adding spatial tactile cues to |
| | | visual scene to | a visual scene may increase |
| | | improve | performance on spatial orientation |
| | | performance on | tasks by grabbing attention towards |
| | | spatial orientation | visual display of interest. Tactile cues |
| | | tasks | should not be used alone as they may |
| | | | not be ideal for quickly and precisely |
| | | | directing attention (although are |
| | | | effective at grabbing attention). |
| 63 | Multimodal | For navigation | Visual distance judgments from a |
| | | tasks, combine | virtual scene can be inaccurate. |
| | | visual presentation | Adding additional cues, either haptic |
| | | with haptic | feedback or 3D audio, may create |
| | | feedback and/or | more accurate spatial knowledge. |
| | | 3D auditory cues | Ensure information from different |
| | | to indicate | modalities is close temporally or |
| | | heading, location, | spatially. |
| | | distance | |
| 64 | Multimodal | Haptics can be | |
| | | coupled to | |
| | | auditory signals to | |
| | | increase reaction | |
| | | time | |
| 65 | Multimodal | Integrate speech | |
| | | output with other | |
| | | modalities (e.g., | |
| | | integrating a voice | |
| | | interface with a | |
| | | touch display) | |
| | | because current | |
| | | speech information | |
| | | may be very poor | |
| | | or difficult to use | |
| 66 | Multimodal | Pair speech with | Speech detection increases more when |
| | | visual cues (i.e., | visual cues (i.e., facial movements) are |
| | | facial movements; | paired with auditory stimuli than when |
| | | lip reading) to | auditory stimuli were presented alone. |
| | | enhance speech | Designers must be cautious of cross- |
| | | detection | modal illusions that may occur when |
| | | | these two modalities are combined, |
| | | | such as the McGurk effect (what the |
| | | | observer hears is influenced by what |
| | | | he or she sees). To avoid incorrect |
| | | | perceptions and to activate necessary |
| | | | auditory cortices to ensure proper |
| | | | verbal processing when using visual- |
| | | | auditory displays to convey verbal |
| | | | information, it may be beneficial to |
| | | | use lip-synched animated agents (with |
| | | | valid speech mouth movements) or |
| | | | videotape a live speaker. |
| 67 | Multimodal | Precede visual | |
| | | information with | |
| | | an auditory alert | |
| | | tone to enhance | |
| | | perception. | |

Once overload-alleviating guidelines are established, the method may further include identifying an event associated with an information system producing a potential sensory overload condition for a human interacting with the system 14. In an aspect of the invention, identifying an event may include characterizing event information associated with the event. For example, the event information may be characterized according to a task category associated with event, such as a communication task required to be performed by the operator, a type of cognitive demand on the user associated with the task, a timing of the task, such as a frequency and/or duration of the task, a display and/or input mode used for the task, and/or a task priority associated with the event. An example task categorization list for a communication task in a shipborne C4ISR system is shown in Table 2 below:

TABLE 2
Example Task Categorization List for a Communication Task

| | | | | Type of | | | |
|---|---|---|---|---|---|---|---|
| Task | Task Sub- | | | Activity | | | |
| Category | Category | No. | Task | for Task | Duration | | Priority |
| COMM | Transmit | 1 | Weather | Speech | 3 | s | 1 |
| | Information | | Information - | | | | |
| | | | tactical | | | | |
| | | | significance | | | | |
| | | 2 | | Chat | 5 | s | 1 |
| | | 3 | Weather | Speech | 7 | s | 0 |
| | | | information - | | | | |
| | | | general forecast | | | | |
| | | | info | | | | |
| | | 4 | | Chat | 10 | s | 0 |
| | | 5 | Request/respond | Speech | 3 | s | 2 |
| | | | to CO | | | | |
| | | 6 | | Chat | 5 | s | 2 |
| | | 7 | Request/respond | Speech | 3 | s | 1 |
| | | | to CIC team | | | | |
| | | | member - tactical | | | | |
| | | 8 | | Chat | 5 | s | 1 |
| | | 9 | Request/respond | Speech | 3 | s | 0 |
| | | | to CIC team | | | | |
| | | | member - non- | | | | |
| | | | tactical | | | | |
| | | 10 | | Chat | 5 | s | 0 |
| | | 11 | Direct movement | Speech | 3 | s | 2 |
| | | | of entity (i.e., | | | | |
| | | | direct movement | | | | |
| | | | of ownership) | | | | |
| | | 12 | | Chat | 5 | s | 2 |
| | | 13 | Direct entity for | Speech | 7 | s | 2 |
| | | | information | | | | |
| | | | gathering mission | | | | |
| | | | (e.g., direct helo | | | | |
| | | | to obtain | | | | |
| | | | surveillance | | | | |
| | | | video of threat | | | | |
| | | | area) | | | | |
| | | 14 | | Chat | 10 | s | 2 |
| | | 15 | Request visual ID | Speech | 3 | s | 1 |
| | | | of target (i.e., | | | | |
| | | | from bridge of | | | | |
| | | | ship) | | | | |
| | | 16 | | Chat | 5 | s | 1 |
| | | 17 | Create/transmit | Paper | 10 | min | 2 |
| | | | daily intension | | | | |
| | | | message | | | | |
| | | 18 | Create/pass on | Paper | 15 | min | 1 |
| | | | turnover papers | | | | |
| | Receive | 19 | Weather | Audio | 3 | s | 1 |
| | Information | | Information - | | | | |
| | | | tactical | | | | |
| | | | significance | | | | |
| | | 20 | | Chat | 5 | s | 1 |
| | | 21 | Weather | Audio | 7 | s | 0 |
| | | | information - | | | | |
| | | | general forecast | | | | |
| | | | info | | | | |
| | | 22 | | Chat | 10 | s | 0 |
| | | 23 | Receive | Audio | 3 | s | 2 |
| | | | Request/information | | | | |
| | | | from CO | | | | |
| | | 24 | | Chat | 5 | s | 2 |
| | | 25 | Receive | Audio | 3 | s | 1 |
| | | | Request/information | | | | |
| | | | from CIC team member - | | | | |
| | | | tactical | | | | |
| | | 26 | | Chat | 5 | s | 1 |
| | | 27 | Receive | Audio | 3 | s | 0 |
| | | | Request/information | | | | |
| | | | from CIC team member - | | | | |
| | | | non-tactical | | | | |
| | | 28 | | Chat | 5 | s | 0 |
| | | 29 | Receive alert | Audio | 3 | s | 2 |
| | | | information | | | | |
| | | 30 | | Chat | 5 | s | 2 |
| | | 31 | Receive/review | Audio | 5 | min | 1 |
| | | | sitreps | | | | |
| | | 32 | | Chat | 5 | min | 1 |
| | | 33 | Receive/review | Audio | 5 | min | 1 |
| | | | daily intension | | | | |
| | | | message | | | | |
| | | 34 | | Chat | 5 | min | 1 |
| | | 35 | | paper | 5 | min | 1 |

After characterizing event information, such as by categorizing task information, the method may include assigning cognitive processing values to the events. The cognitive processing values may be assigned according to processing categories associated with the event activity, such as a stimulus category, a cognitive category, and/or a response category. The stimulus category may include incoming stimulus sensory channels, such as visual, auditory, and haptic stimuli. The cognitive category may include two cognition types, such as spatial cognition and verbal cognition type. The response category may include two response types, such as a motor or speech response. Respective cognitive processing values may be assigned to each of the categories that are used in receiving and responding to an input from an information system. In an aspect of the invention, cognitive processing values may be assigned according to known valuation techniques that rate cognitive processing workloads corresponding to processing categories on a subjective scale, such as a 7 point scale wherein 0 represents very low attention demand on an operator and 7 represent a very high attention demand on an operator. An example cognitive processing workload scoring scale for various sensory channels is shown in Table 3:

TABLE 3
Cognitive Processing Workload Scoring Scale

| | | Demand |
|---|---|---|
| Channel | Nature Of The Demand Descriptors | Value |
| VISUAL | Visual Resource Not Used | 0.0 |
| | Visually Register/Detect (Detect Occurrence of | 3.0 |
| | Image) | |
| | Visually Inspect/Check (Discrete Inspection/Static | 3.0 |
| | Condition) | |
| | Visually Locate/Align (Selective Orientation) | 4.0 |
| | Visually Track/Follow (Maintain Orientation) | 4.4 |
| | Visually Discriminate (Detect Visual Differences) | 5.0 |
| | Visually Read (Symbol) | 5.0 |
| | Visually Read (Text - 1-2 words) | 5.0 |
| | Visually Read (Text - sentence) | 5.8 |
| | Visually Scan/Search Monitor (Continuous/Serial | 6.0 |
| | Inspection) | |
| AUDITORY | Auditory Resource Not Used | 0.0 |
| | Detect/Register Sound (Detect Occurrence of Sound) | 1.0 |
| | Orient to Sound (General Orientation/Attention) | 2.0 |
| | Interpret Semantic Content (Speech) Simple 3 (1-2 | 3.0 |
| | words) | |
| | Orient to Sound (Selective Orientation/Attention) | 4.2 |
| | Verify Auditory Feedback (Detect Occurrence of | 4.3 |
| | Anticipated Sound) | |
| | Interpret Semantic Content (Speech) Complex 6 | 6.0 |
| | (sentence) | |
| | Discriminate Sound Characteristics (Detect Auditory | 6.6 |
| | Differences) | |
| | Interpret Sound Patterns (pulse rates, etc.) | 7.0 |
| HAPTIC | Haptic resource not used | 0.0 |
| | Detect/Register Cue (Detect occurrence of cue) | 1.0 |
| | Orient to Cue (General Orientation/Attention) | 2.0 |
| | Interpret cue content (verbal information) | 3.0 |
| | Orient to Cue (Selective Orientation/Attention) | 4.2 |
| | Discriminate Vibration Characteristics | 6.6 |
| | Interpret Vibration Patterns | 7.0 |
| SPATIAL | Spatial Resource not used | 0.0 |
| | Automotive (Simple Association) | 1.0 |
| | Alternative Selection | 1.2 |
| | Motion perception and tracking (perceive and track | 3.7 |
| | the motion of other moving entities in the | |
| | environment) | |
| | Evaluation/Judgment concerning axes or translation | 4.6 |
| | or rotation (Visualization of space or items in space, | |
| | visualization of 3D objects or environments, maps) | |
| | Rehearsal of spatial location | 5.0 |
| | Encoding/Decoding, Recall of spatial items | 5.3 |
| | Localization of self and/or others | 6.8 |
| | Interpolation/extrapolation of continuous functions | 7.0 |
| VERBAL | Verbal Resource not used | 0.0 |
| | Automotive (Simple Association) | 1.0 |
| | Alternative Selection | 1.2 |
| | Signal/Sign Recognition of verbal items | 3.7 |
| | Evaluation/Judgment (Single aspect of general | 4.6 |
| | symbols, icons, and other figures translated into | |
| | linguistic items) | |
| | Rehearsal or verbal items (Review of steps or actions | 5.0 |
| | to be taken, includes checking against a plan) | |
| | Encoding/Decoding, Recall of verbal items | 5.3 |
| | Evaluation/Judgment (multiple aspects including | 6.8 |
| | reasoning of abstract representations of real-world | |
| | information) | |
| | Estimation, Calculation, Conversion (Calculations of | 7.0 |
| | distance, time, ordering, priority) | |
| MOTOR | Motor Response not used | 0.0 |
| | Discrete Actuation (Button, Toggle, Trigger) | 2.2 |
| | Continuous Adjustive (Flight Control, Sensor | 2.6 |
| | Control) | |
| | Manipulative | 4.6 |
| | Discrete Adjustive (Rotary, Vertical Thumb Wheel, | 5.5 |
| | Lever Position) | |
| | Symbolic Production (Writing) | 6.5 |
| | Serial Discrete Manipulation (Keyboard) | 7.0 |
| SPEECH | Speech Response not used | 0.0 |
| | Simple (1-2 words) | 2.0 |
| | Complex (sentence) | 3.0 |

After assigning cognitive processing values to the events, such as by using the scoring values presented in Table 3, a predicted workload may be calculated for one or more events, such as by summing the cognitive processing values from the processing categories associated with the invention. For example, a predicted workload for an event may be calculated using Equation 1:

W_{T}=ΣΣa_{t,i}+Σ[(n_{t,i}−1)cᵢᵢΣa_{t,i}]+ΣΣcᵢⱼΣ(a_{t,i}+aₜⱼ) 1.

wherein W_{T} is the total predicted workload at time T, a_{t,i} represents the attention (e.g., cognitive processing value) corresponding to a human interface channel i to perform a task t, n_{t,i} represents the number of tasks occurring at time t with attention being given to channel i, and cᵢⱼ represents a conflict between channels i and j. Accordingly, the first term represents a sum of an attention demand requirement placed on an operator during the event, the second term represents a penalty due to attention demand conflicts within the same channel, and the third term represents a penalty due to attention demand conflicts between different channels. It has been experimentally determined that a total predicted workload of 40 or more is indicative of potential operator sensory overload.

When a sensory overload condition for one or more events has been identified, the method may include generating a human interface design solution based on the guidelines for modifying the operating condition of the system to help alleviate the potential sensory overload condition associated with the event. The design solution may be based on the guidelines presented in Table 1 and knowledge of an operating condition of the system when an overload event has been identified. A system design solution may be suggested to alter the presentation of information by the system to reduce a likelihood of an operator experiencing sensory overload in response to the event. For example, a solution to a sensory overload condition caused by a stimulus to a primary sense, such as a visual cue, may be to generate a stimulus for a secondary sense, such as an auditory cue. Table 4 below includes example design solutions for sensory overload conditions that are based at least in part on the example guidelines presented in Table 2.

TABLE 4
Example Design Solutions for Sensory Overload Conditions

| OVERLOAD | Stimulus | Cognitive | Response | Duration | | Priority | Interface | SOLUTION |
|---|---|---|---|---|---|---|---|---|
| Visual | 3.0 Visually | | | | | | | Use congruent pairings of |
| channel | register/ | | | | | | | color and position to |
| overloaded | detect (detect | | | | | | | reduce reaction time |
| | occurrence of | | | | | | | |
| | image) | | | | | | | |
| Visual | 3.0 Visually | | | | | | | Use motion to enhance |
| channel | register/ | | | | | | | detection of objects in the |
| overloaded | detect (detect | | | | | | | periphery or overcome poor |
| | occurrence of | | | | | | | illumination |
| | image) | | | | | | | |
| Visual | 3.0 Visually | | | | | High | | Precede visual information |
| channel | register/ | | | | | | | with an auditory alert tone. |
| overloaded | detect (detect | | | | | | | |
| | occurrence of | | | | | | | |
| | image) | | | | | | | |
| Visual | 3.0 Visually | | | | | | | Use vibratory/tactile cues |
| channel | register/ | | | | | | | for alerts/warning |
| overloaded | detect (detect | | | | | | | |
| | occurrence of | | | | | | | |
| | image) | | | | | | | |
| Visual | 3.0 Visually | | | | | | | Auditory cues added to a |
| channel | register/ | | | | | | | visual target detection task |
| overloaded | detect (detect | | | | | | | are beneficial, especially |
| | occurrence of | | | | | | | when a shift in gaze is |
| | image) | | | | | | | required (e.g., in the |
| | | | | | | | | periphery) |
| Visual | 4.0 Visually | | | | | | | Combine tactile cues with |
| channel | locate/align | | | | | | | the visual scene to |
| overloaded | (selective | | | | | | | improve performance |
| | orientation) | | | | | | | on spatial orientation |
| | | | | | | | | tasks |
| Visual | 4.4 Visually | | | | | | | For navigation tasks, |
| channel | track/follow | | | | | | | combine visual presentation |
| overloaded | (maintain | | | | | | | with haptic feedback |
| | orientation) | | | | | | | and/or 3D auditory |
| | | | | | | | | cues to indicate |
| | | | | | | | | heading, location, |
| | | | | | | | | distance |
| Visual | 4.4 Visually | | | | | | | Distribute attention |
| channel | track/follow | | | | | | | amongst a range of |
| overloaded | (maintain | | | | | | | visual characteristics |
| | orientation) | | | | | | | of objects (i.e., |
| | | | | | | | | shape, color, speed) to |
| | | | | | | | | minimize cognitive |
| | | | | | | | | workload |
| Visual | 5.0 Visually | | | | | | | Auditory icons are useful |
| channel | read (symbol) | | | | | | | when visual channel |
| overloaded | | | | | | | | overloaded |
| Visual | 5.0 Visually | | | | | | | Auditory icons are useful |
| channel | discriminate | | | | | | | when visual channel |
| overloaded | (detect visual | | | | | | | overloaded |
| | differences) | | | | | | | |
| Visual | 6.0 Visually scan/ | | | | | | | Distribute attention |
| channel | search/ monitor | | | | | | | amongst a range of |
| overloaded | (continuous/ | | | | | | | visual characteristics |
| | serial inspection) | | | | | | | of objects (i.e., |
| | | | | | | | | shape, color, speed) to |
| | | | | | | | | minimize cognitive |
| | | | | | | | | workload |
| Visual | Any visual | | | | | | | Add a tactile cue to direct |
| channel | score >0 | | | | | | | multimodal interaction. |
| overloaded | | | | | | | | |
| Visual | | 6.8 Spatial - | | | | | | Tactile cues can be |
| channel | | localization | | | | | | augmented by or substituted |
| overloaded | | of self | | | | | | for visual tasks to aid |
| | | and/or others | | | | | | localization |
| Visual | 2 visual/verbal | | | | | | | Present highest priority |
| channel | tasks | | | | | | | verbal task using audio |
| overload | | | | | | | | instead of visual input. |
| Visual | 2 visual/verbal | | | | | | | Present one task at a time: |
| channel | tasks | | | | | | | Hold lowest priority task in |
| overload | | | | | | | | cue until highest priority |
| | | | | | | | | task is complete. |
| Visual | 4.0 Visually | | | | | | | Add spatialized audio to |
| channel | locate/align | | | | | | | visual target detection |
| overload | (selective | | | | | | | tasks to decrease search |
| | orientation) | | | | | | | times |
| Visual | 5.0 Visually read | | | | | | | Use auditory messages |
| channel | (text - 1-2 words) | | | | | | | if dealing with |
| overload | | | | | | | | time relevant |
| | | | | | | | | events, continuously |
| | | | | | | | | changing information, |
| | | | | | | | | or when requiring |
| | | | | | | | | immediate action |
| Visual | 6.0 Auditory: | | | | | | | Pair speech with visual cues |
| NOT | interpret | | | | | | | (i.e., facial movements; lip |
| overloaded | semantic content | | | | | | | reading) to enhance speech |
| | (speech - sentence) | | | | | | | detection |
| Visual | 6.0 Auditory: | | | | | | | Pair speech with visual cues |
| NOT | interpret | | | | | | | (i.e., facial movements; lip |
| overloaded | semantic content | | | | | | | reading) to enhance speech |
| | (speech - 1-2 words) | | | | | | | detection |
| Auditory | 1.0 Detect/ | | | | | | | Vibratory cues can replace |
| channel | Register sound | | | | | | | auditory cues for alerts/ |
| overload | (detect occurrence | | | | | | | warnings |
| | of sound) | | | | | | | |
| Auditory | 2.0 Orient to | | | | | | | Vibratory cues can replace |
| channel | sound (general | | | | | | | auditory cues for alerts/ |
| overload | orientation/ | | | | | | | warnings |
| | attention) | | | | | | | |
| Auditory | 4.2 Orient to | | | | | | | Vibratory cues can replace |
| channel | sound (selective | | | | | | | auditory cues for alerts/ |
| overload | orientation/ | | | | | | | warnings |
| | attention) | | | | | | | |
| Auditory | 6.0 Auditory: | | | | | | | Never present two verbal |
| channel | interpret | | | | | | | messages at the same time |
| overload | semantic content | | | | | | | Offload in time/pacing |
| | (speech - sentence) | | | | | | | |
| Auditory | 6.0 Auditory: | | | Long | | | | Text is better than speech |
| channel | Interpret | | | | | | | for conveying detailed, long |
| overload | Semantic content | | | | | | | information |
| | (speech - sentence) | | | | | | | |
| Auditory | 6.0 Interpret | | | | | | | Keep auditory warning |
| channel | semantic content | | | | | | | messages simple and short |
| overload | (speech-sentence) | | | | | | | |
| Auditory | 7.0 Interpret Sound | | | | | | | Use auditory icons (with |
| channel | Patterns (pulse | | | | | | | real world sounds) to |
| overload | rates, etc). | | | | | | | enhance their recognizability |
| Auditory | 7.0 Interpret Sound | | | | | | | Use timbres with multiple |
| channel | Patterns (pulse | | | | | | | harmonics to aid perception |
| overload | rates, etc). | | | | | | | of critical items while |
| | | | | | | | | avoiding masking |
| Spatial | Auditory score >0 | 6.8 Spatial - | | | | | | Use visual graphics for |
| channel | for spatial task | localization | | | | | | communicating spatial |
| overloaded | | of self | | | | | | information |
| | | and/or others | | | | | | |
| Spatial | Auditory score >0 | 6.8 Spatial - | | | | | | Present highest priority |
| channel | for spatial task | localization | | | | | | spatial task using visual |
| overloaded | | of self | | | | | | channel instead of auditory |
| | | and/or others | | | | | | channel. |
| Spatial | Auditory score >0 | 6.8 Spatial - | | | | | | Add tactile cues to spatial |
| channel | for spatial task | localization | | | | | | tasks to aid localization. |
| overloaded | | of self | | | | | | |
| | | and/or others | | | | | | |
| Spatial | Visual score >0 | 6.8 Spatial - | | | | | | Tactile cues can be |
| channel | for spatial task | localization | | | | | | augmented by or substituted |
| overloaded | | of self | | | | | | for visual tasks to aid |
| | | and/or others | | | | | | localization |
| Spatial | 2 visual/spatial | | | | | | | Present one task at a time: |
| channel | tasks | | | | | | | Hold lowest priority spatial |
| overload + | | | | | | | | task in cue until highest |
| visual | | | | | | | | priority task is complete. |
| channel | | | | | | | | |
| overload | | | | | | | | |
| Spatial | 2 visual/spatial | | | | | | | Present lowest priority |
| channel | tasks | | | | | | | spatial task using |
| overload + | | | | | | | | spatialized audio cues |
| visual | | | | | | | | instead of visual input |
| channel | | | | | | | | |
| overload | | | | | | | | |
| Spatial | 2 visual/spatial | | | | | | | Present lowest priority |
| channel | tasks | | | | | | | spatial task using |
| overload + | | | | | | | | spatialized tactile cues |
| visual | | | | | | | | instead of visual input |
| channel | | | | | | | | |
| overload | | | | | | | | |
| Verbal | 2 visual/verbal | | | | | | | Present highest priority |
| channel | tasks | | | | | | | verbal task using |
| overload | | | | | | | | audio instead of visual |
| | | | | | | | | input. |
| Verbal | 2 visual/verbal | | | | | | | Present one task at a time: |
| channel | tasks | | | | | | | Hold lowest priority verbal |
| overload | | | | | | | | task in cue until highest |
| | | | | | | | | priority task is complete. |
| Verbal | 5.0 Visually read | | | <5 | s | | | Present short lists using |
| channel | (text - 1-2 | | | | | | | auditory channel instead |
| overload | words) | | | | | | | of visual text. |
| Verbal | 7.0 Auditory | | | >5 | s | | | Use visual text for |
| channel | Interpret | | | | | | | conveying detailed, long |
| overload | semantic content | | | | | | | information. |
| | (speech - sentence) | | | | | | | |
| Verbal | 7.0 Auditory | | | | | | | Add spatialized audio to aid |
| channel | Interpret sound | | | | | | | identification of auditory |
| overload | patterns (pulse | | | | | | | verbal messages in noisy |
| | rates, etc.) | | | | | | | environments. |
| Motor | | | | | | | | Use speech as a |
| channel | | | | | | | | response method if |
| overload | | | | | | | | user's hands are busy. |
| Speech | | | | | | | | |
| channel | | | | | | | | |
| overload | | | | | | | | |
| | Any visual | | | | | | | Use Gestalt Rules to |
| | score >0; not | | | | | | | increase users' |
| | visually read | | | | | | | understanding of |
| | (text) | | | | | | | relationships between |
| | | | | | | | | elements |
| | 3.0 Visually | | | Short | | High | | Reaction time to visual |
| | register/detect | | | | | | | stimuli (180-200 msec) is |
| | (detect | | | | | | | slower than auditory |
| | occurrence of | | | | | | | (140-160 msec) and |
| | image) | | | | | | | haptic (155 msec), |
| | | | | | | | | thus it is best to use |
| | | | | | | | | visual alerts and warnings |
| | | | | | | | | only when these other |
| | | | | | | | | modalities are loaded |
| | 3.0 Visually | | | | | | One task not | To examine object details, |
| | inspect/check | | | | | | on main visual | place object within foveal |
| | (discrete | | | | | | interface | vision (central 2° of |
| | inspection/static | | | | | | | retina; |
| | condition) | | | | | | | |
| | 5.0 Visually | | | | | | | Use animation to demonstrate |
| | read (symbol) | | | | | | | sequential actions in |
| | | | | | | | | procedural tasks, |
| | | | | | | | | simulate causal models |
| | | | | | | | | of complex system |
| | | | | | | | | behavior, and explicitly |
| | | | | | | | | represent invisible |
| | | | | | | | | system functions and |
| | | | | | | | | behaviors |
| | 5.0 Visually read | Verbal task + | | | | | | Provide aural rather than |
| | (text - 1-2 | second task | | | | | | textual instructions |
| | words) + | | | | | | | when a listener is |
| | second visual | | | | | | | performing a visual task |
| | task | | | | | | | |
| | 5.0 Visually read | | | Short | | | | Speech is most effective for |
| | (text - 1-2 | | | | | | | rapid, complex information |
| | words) | | | | | | | |
| | 5.8 Visually read - | Spatial - | | | | | | Graphics are better than |
| | text (sentence) | encoding/ | | | | | | text or auditory |
| | | decoding, recall | | | | | | instructions for |
| | | of spatial items | | | | | | communicating |
| | | | | | | | | spatial information |
| | 5.0 Visually | | | | | | | Avoid absolute judgment |
| | discriminate | | | | | | | (recognition tasks) via |
| | (detect visual | | | | | | | color |
| | differences) | | | | | | | |
| | 5.0 Visually | | | | | | | Make sure that the display |
| | discriminate | | | | | | | can be used without color |
| | (detect visual | | | | | | | (e.g., for color-blind |
| | differences) | | | | | | | individuals) |
| | 5.0 Visually | | | | | | | Design displays such that |
| | discriminate | | | | | | | they require relative |
| | (detect visual | | | | | | | judgment via color |
| | differences) | | | | | | | (differentiation tasks) |
| | 5.0 Visually | | | | | | | Use color to aid visual |
| | discriminate | | | | | | | search by making images |
| | (detect visual | | | | | | | discriminable from one |
| | differences) | | | | | | | another |
| | 5.0 Visually | | | | | | | Use numbered lists to show |
| | discriminate | | | | | | | groups of related items |
| | (detect visual | | | | | | | with a specific order |
| | differences) | | | | | | | |
| | 5.0 Visually | | | | | | | Use flow charts to show |
| | discriminate | | | | | | | relationships or steps |
| | (detect visual | | | | | | | involved in a process |
| | differences) | | | | | | | |
| | 5.0 Visually | | | | | | | Use tables, matrices, bar |
| | discriminate | | | | | | | charts, pie charts for |
| | (detect visual | | | | | | | appropriate uses . . . |
| | differences) | | | | | | | |
| | 1.0 Auditory: | | | | | | | Use congruent pairings of |
| | Detect/Register | | | | | | | pitch and position to |
| | sound (detect | | | | | | | reduce reaction time |
| | occurrence of | | | | | | | |
| | sound) | | | | | | | |
| | 1.0 Auditory: | | | | | | | Keep auditory warning |
| | Detect/Register | | | | | | | messages simple and short |
| | sound (detect | | | | | | | |
| | occurrence of | | | | | | | |
| | sound) | | | | | | | |
| | 1.0 Auditory: | | | | | | | Use complex sounds for |
| | Detect/Register | | | | | | | alarms |
| | sound (detect | | | | | | | |
| | occurrence of | | | | | | | |
| | sound) | | | | | | | |
| | 1.0 Auditory: | | | <500 | ms | | | If duration <500 ms, |
| | Detect/Register | | | | | | | increase intensity to |
| | sound (detect | | | | | | | compensate for audibility as |
| | occurrence of | | | | | | | sounds shorter than 500 ms |
| | sound) | | | | | | | may not be perceived. |
| | 2.0 Auditory: | | | | | High | | Haptics can be coupled to |
| | orient to sound | | | | | | | auditory signals to increase |
| | (general | | | | | | | reaction time |
| | orientation/ | | | | | | | |
| | attention) | | | | | | | |
| | 2.0 Auditory: | | | | | | | Auditory cues |
| | orient to sound | | | | | | | can be spatialized to |
| | (general | | | | | | | indicate direction, |
| | orientation/ | | | | | | | location, and movement |
| | attention) | | | | | | | |
| | 3.0 Auditory: | | | | | | | Simulate human voices |
| | interpret | | | | | | | as much as possible |
| | semantic content | | | | | | | when using speech |
| | (speech - 1-2 words) | | | | | | | |
| | 3.0 Auditory: | | | | | | | Use different voices |
| | interpret | | | | | | | for different interface |
| | semantic content | | | | | | | elements |
| | (speech - 1-2 words) | | | | | | | |
| | 4.2 Auditory: | | | | | High | | Haptics can be coupled to |
| | orient to sound | | | | | | | auditory signals to increase |
| | (selective | | | | | | | reaction time |
| | orientation/ | | | | | | | |
| | attention) | | | | | | | |
| | 4.2 Auditory: | | | | | | | Auditory cues can be |
| | orient to sound | | | | | | | spatialized to indicate |
| | (selective | | | | | | | direction, location, and |
| | orientation/ | | | | | | | movement |
| | attention) | | | | | | | |
| | 6.0 Auditory: | | | | | | | Simulate human voices |
| | interpret | | | | | | | as much as possible when |
| | semantic content | | | | | | | using speech |
| | (speech - sentence) | | | | | | | |
| | 6.0 Auditory: | | | | | | | Use different voices for |
| | interpret | | | | | | | different interface elements |
| | semantic content | | | | | | | |
| | (speech - sentence) | | | | | | | |
| | 6.0 Auditory: | 5.3 Spatial - | | | | | | Graphics are better than |
| | interpret | encoding/ | | | | | | text or auditory instructions |
| | semantic content | decoding, | | | | | | for communicating spatial |
| | (speech - sentence) | recall of | | | | | | information |
| | | spatial items | | | | | | |
| | 6.6 Auditory: | | | | | | | A warning sound |
| | discriminate | | | | | | | must be 15 dB above |
| | sound | | | | | | | the threshold imposed |
| | characteristics | | | | | | | by background noise |
| | (detect auditory | | | | | | | to be heard clearly. |
| | differences) | | | | | | | |
| | 6.6 Auditory: | | | | | | | If pitch, register or |
| | discriminate | | | | | | | rhythm are used alone to |
| | sound | | | | | | | make absolute sound |
| | characteristics | | | | | | | judgments, use a large |
| | (detect auditory | | | | | | | difference between |
| | differences) | | | | | | | earcons (pitch: 125 Hz- |
| | | | | | | | | 5 kHz; register: 3 or |
| | | | | | | | | more octaves; rhythm: |
| | | | | | | | | different number of |
| | | | | | | | | notes in each) |
| | 6.6 Auditory: | | | | | | | Intensity should not |
| | discriminate | | | | | | | be used alone for |
| | sound | | | | | | | differentiating earcons |
| | characteristics | | | | | | | |
| | (detect auditory | | | | | | | |
| | differences) | | | | | | | |
| | 6.6 Auditory: | | | | | | | If combining intensity |
| | discriminate | | | | | | | differences with other |
| | sound | | | | | | | auditory cues, use a |
| | characteristics | | | | | | | minimum intensity of 10 |
| | (detect auditory | | | | | | | dB above threshold and |
| | differences) | | | | | | | maximum intensity of 20 |
| | | | | | | | | dB above threshold |
| | 6.6 Auditory: | | | | | | | When playing sequential |
| | discriminate | | | | | | | earcons, use a 0.1 s delay |
| | sound | | | | | | | between them so listeners |
| | characteristics | | | | | | | can tell when one finishes |
| | (detect auditory | | | | | | | and the next commences |
| | differences) | | | | | | | |
| | 1.0 Haptic: | | | | | | | Avoid unpredictable |
| | detect/register | | | | | | | tactile stimuli, as they |
| | cue (detect | | | | | | | tend to increase cortical |
| | occurrence of | | | | | | | activation |
| | cue) | | | | | | | |
| | 2.0 Haptic: orient | | | | | High | | Auditory signals can be |
| | to cue (general | | | | | | | coupled to haptic signals |
| | orientation/ | | | | | | | to increase reaction time |
| | attention) | | | | | | | |
| | 4.2 Haptic: orient | | | | | High | | Auditory signals can be |
| | to cue | | | | | | | coupled to haptic signals |
| | (selective | | | | | | | to increase reaction time |
| | orientation/ | | | | | | | |
| | attention) | | | | | | | |
| | 6.6 Haptic: | | | | | | | Stimuli must be separated |
| | discriminate | | | | | | | by at least 5.5 ms to |
| | vibration | | | | | | | be perceived as individual |
| | characteristics | | | | | | | signals |
| | | Verbal | | <5 | s | High | | Present low complexity, |
| | | 5.3 or | | | | | | high priority information |
| | | less | | | | | | through the auditory |
| | | | | | | | | channel. |
| | | Spatial | | <5 | s | High | | Present low complexity, |
| | | 1.2 or | | | | | | high priority information |
| | | less | | | | | | through the auditory |
| | | | | | | | | channel. |
| | | Verbal | | >5 | s | Low | | Present high complexity, |
| | | 6.8 or | | | | | | low priority information |
| | | more | | | | | | through the visual channel. |

The above-described method may be used, for example, when redesigning a system. The method may used to modify an existing system to improve information presentation, such as by assessing overload conditions, generating a solution, redesigning the system according to the suggested solutions. In another aspect, an on-line approach may be used to modify a system, for example, based on overload condition identified during use and then implementing a design solution while the system is operating.

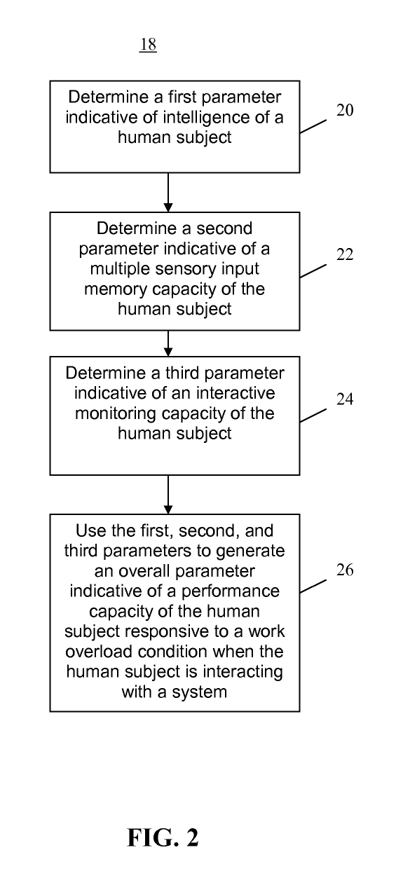

In another aspect of the invention, a method is provided for predicting a performance capability of a human subject interacting with a system, for example, to identify operators having superior information processing abilities that may be best suited to operate complex information systems. FIG. 2 shows an example flow chart 18 of a method for predicting a performance capability of a human subject interacting with an information system. The method includes determining a first parameter indicative of intelligence of a human subject 20 such as by using a general intelligence, or intelligence quotient (IQ), test to assess a subject's mental ability. For example, a test such as Raven's Progressive Matrices, may be used to test a subject to determine a first parameter, such as a test score to be used in predicting the subject's information processing abilities.

The method may also include determining a second parameter indicative of a multiple sensory input memory, or working memory, capacity of the human subject 22. Working memory reflects a limited capacity of the human brain for allowing temporary storage and manipulation of information for complex tasks as comprehension, learning, and reasoning. Accordingly, a working memory capacity assessment may be used to rate a subject's reasoning, decision making and planning abilities. In an embodiment of the invention, a method for determining a working memory capacity may include assessing a subject's ability to process multiple streams of information coming from different sensory sources, such as by testing a subject's memory of information presented to the subject via different sensory channels. The method may include presenting a subject with one or more visual, text, picture, speech, spatialized tones, and/or spatialized haptic cue stimuli and then assessing the subject's ability to recall the stimuli presented and/or the types of stimuli remembered. A score based on the above working memory capacity test may be used as the second parameter for predicting the subject's information processing abilities.

The method may also include determining a third parameter indicative of an interactive monitoring capacity of the human subject 24, such as by testing a subject's ability to dynamically interact with a simulated system to predict the subject's performance within a desired operational environment. For example, an interactive monitoring test similar to the known Federal Aviation Administration's (FAA) Air Traffic Selection and Training exam may be used to test a subject to determine the third parameter, such as a test score, to be used in predicting the subject's information processing abilities.

While each of the above-described tests may separately provide an indication of an operator's ability to perform in certain environment, the inventors have realized that a combination of the tests may provide a better characterization of a subject's performance capability with regard to information processing. Accordingly, the method further includes using the first, second, and third parameters to generate an overall parameter indicative of a performance capacity of the subject 26, for example, responsive to a work overload condition when the human subject is interacting with a system. It has been experimentally determined that the overall parameter derived using the above method provides a better indication of information processing capability than any one of the tests separately.

Based on the foregoing, the invention may be implemented using computer programming or engineering techniques including computer software, firmware, hardware or any combination or subset thereof, wherein the technical effect is to generate design solutions for designing a human interface of an information system and generate a performance parameter for use in predicting a performance capability of a human subject interacting with a system. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention.

Although several embodiments of the present invention and its advantages have been described in detail, it should be understood that mutations, changes, substitutions, transformations, modifications, variations, and alterations can be made therein without departing from the teachings of the present invention, the spirit and scope of the invention being set forth by the appended claims.

What is claimed is:

1. A method for evaluating a human interface of a system for appropriate allocation of design guidance comprising:
establishing guidelines for avoiding sensory overload conditions of a human interacting with a system;
identifying an event associated with the system producing a potential sensory overload condition; and
generating a human interface design recommendation based on the guidelines for modifying an operation of the system to help alleviate the potential sensory overload condition associated with the event.

2. The method of claim 1, wherein the design recommendation comprises an instruction to change a presentation of information by the system effective to reduce a likelihood of an operator experiencing sensory overload in response to the event.

3. The method of claim 1, wherein the design recommendation comprises an instruction to convert a first sense stimulus resulting in the event into a second sense stimulus effective to reduce a likelihood of an operator experiencing sensory overload in response to the event.

4. The method of claim 3, wherein the first sense stimulus is directed to at least one of a visual, an auditory, and a haptic sense.

5. The method of claim 1, wherein identifying an event comprises characterizing event information associated with the event.

6. The method of claim 5, wherein characterizing event information comprises organizing the event information into one or more task categories.

7. The method of claim 6, wherein the task categories comprise at least one of a task type, a type of cognitive demand on the user for the task, a timing of the task, a display mode used for the task, an input mode required by the task, and a priority of the task.

9. The method of claim 1, further comprising assigning a cognitive processing value to the event.

10. The method of claim 9, wherein the cognitive processing value is assigned according to at least one of an attention demand requirement placed on an operator during the event, an attention demand conflict in a same sensory channel of the system, and an attention demand conflict in different sensory channels of the system.

11. The method of claim 1, further comprising using the human interface design recommendation to modify the operation of the system while the system is being used.

12. A computer system having a processor, a memory, and an operating environment, the computer system configured for executing the method recited in claim 1.

13. A computer-readable medium having computer-executable instructions for performing the method recited in claim 1.
